(19) United States
(12) Patent Application Publication
(10) Pub. No.: US 2008/0168311 A1
(43) Pub. Date: Jul. 10, 2008

(54) Configuration debugging comparison

(75) Inventor: Paul Matthew Pietrek, Issaquah, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/650,661

(22) Filed: Jan. 8, 2007

(51) Int. Cl. G06F 11/36

(52) U.S. Cl. 714/33; 714/38; 714/E11.21; 714/E11.216

(57) ABSTRACT

Various technologies and techniques are disclosed for performing configuration debugging comparisons. Snapshots are acquired from at least two computer systems to be compared. The snapshots from the computer systems are then compared. Heuristics are used to determine which differences are actually logically equivalent and thus not to be identified as differences. Comparison results are generated and then displayed in a manner that allows a user to see one or more differences identified between the systems. A filtering feature is provided to allow the user to further filter the comparison results based on a type of issue to be diagnosed. A requirements feedback feature is provided to allow the user to add a user-identified difference as a configuration requirement to a system model.

### BACKGROUND

Software programs do not always perform as they are expected to perform on computers for various reasons. One cause for application misbehavior can be because of a missing system configuration, or a configuration that is different than what the software program expects. For example, a software program may run correctly with one particular version of an operating system library but not with another version of the same library. If the software program works on one particular computer but not on another one, it can be difficult and time consuming to determine what is causing the problem.

Some configuration comparison tools exist to allow users to capture snapshots of the computer where the software program is operating correctly and on the computer where the software program is not operating correctly. There are several problems with such comparison tools. First, they require the user to filter through a lot of unnecessary data to try and identify the potential problem. Second, they return a lot of false positives that are not really differences. For example, an identical copy of the C++ runtime library may be found at c:\windows\system32\msvcrt80.dll on one computer, and d:\winnt\system32\msvcrt80.dll on another. These files may be highlighted as differences by a configuration comparison tool, but they are really the same logically.

### SUMMARY

Various technologies and techniques are disclosed for performing configuration debugging comparisons. Snapshots are acquired from at least two computer systems to be compared. The snapshots from the computer systems are then compared to identify the differences. In one implementation, heuristics are used to determine which differences are actually logically equivalent and thus not to be identified as differences. Comparison results are generated and then displayed in a manner that allows a user to see the differences identified between the systems. A filtering feature is provided to allow the user to further filter the comparison results based on a type of issue to be diagnosed.

In one implementation, a requirements feedback feature is provided to allow the user to add a user-identified difference to the system model as a system requirement to be used in future comparisons.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a configuration debugging comparison application of one implementation operating on the computer system of FIG. 1.

FIG. 3 is a logical diagram of a configuration debugging comparison application of FIG. 1 that illustrates one implementation of a process involved in performing a configuration comparison and the flow of data between processes.

FIG. 4 is a high-level process flow diagram for one implementation of the system of FIG. 1.

FIG. 5 is a process flow diagram that illustrates one implementation of the stages involved in providing a snapshot acquisition feature to capture predetermined configuration information from two systems.

FIG. 6 is a process flow diagram that illustrates one implementation of the stages involved in comparing the snapshots from two systems to generate the configuration comparison results.

FIG. 7 is a process flow diagram that illustrates one implementation of the stages involved in displaying the comparison results to the user in a format that allows the user to determine the configuration differences between the two systems.

FIG. 8 is a process flow diagram that illustrates one implementation of the stages involved in providing a requirements feedback feature that allows the user to add a user-identified difference to the system model.

FIG. 9 is a simulated screen of one implementation of the system of FIG. 1 that illustrates a comparison results data file that has been transformed from a source format into a format that is more readable in a web browser.

FIG. 10 is a simulated screen of one implementation of the system of FIG. 1 that illustrates comparison results data being displayed according to the implied hierarchy of the data to display the differences in a meaningful fashion to the user.

FIG. 11 is a simulated screen of one implementation of the system of FIG. 1 that illustrates a requirements feedback feature that allows a user to update the system model with a particular requirement.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application for comparing system configurations between computers, but the system also serves other purposes in addition to these. In one implementation, one or more of the techniques described herein can be implemented as features within a software development program such as MICROSOFT® VISUAL STUDIO®, or from any other type of program or service that allows a user to perform a comparison of two or more system configurations.

In one implementation, a configuration debugging comparison application is provided that allows the configurations of different computers to be compared to identify where there are differences that may be causing a particular problem. Snapshots are taken of the configuration settings for the different computers, such as one that has a particular software program operating normally and one that is not working correctly. The snapshots are then compared, and heuristics are used to reduce the amount of noise (e.g. false positives) present in the results. The results are then displayed to the user in a format that allows them to see the differences. The user can apply filters to further reduce the volume and/or order of the data in the results list to more easily identify the problem.

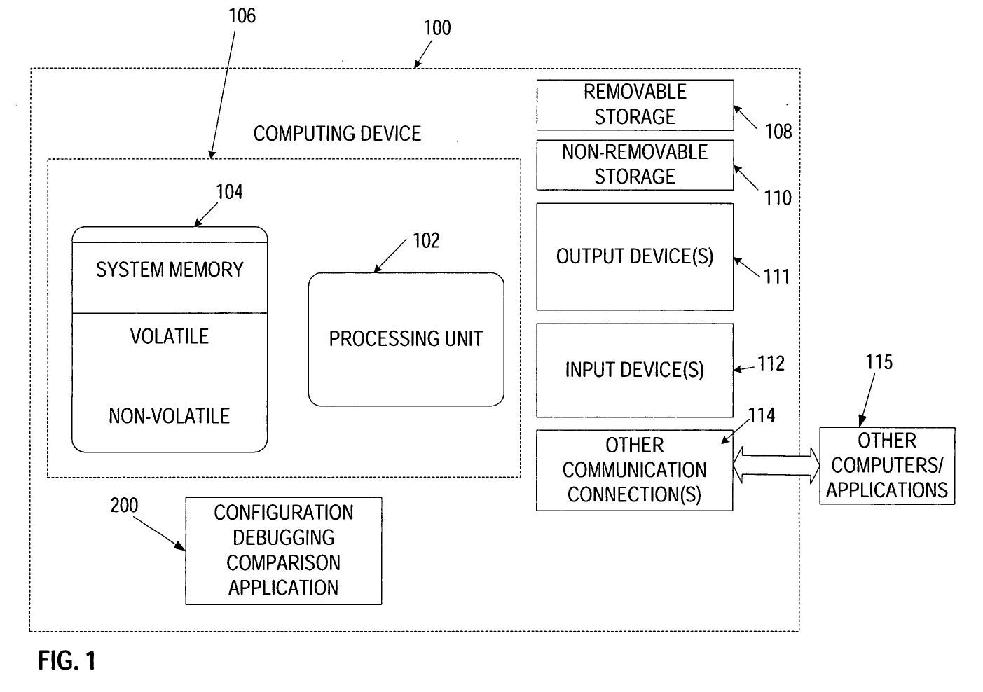

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

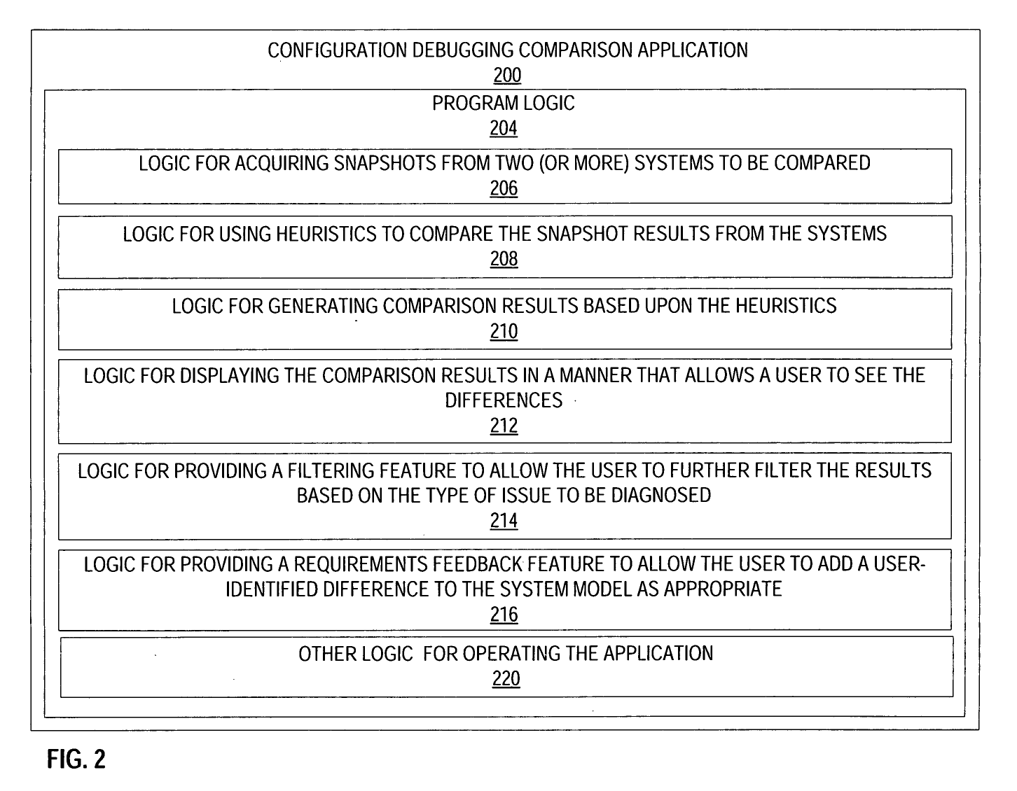

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes configuration debugging comparison application 200. Configuration debugging comparison application 200 will be described in further detail in FIG. 2.

Turning now to FIG. 2 with continued reference to FIG. 1, a configuration debugging comparison application 200 operating on computing device 100 is illustrated. Configuration debugging comparison application 200 is one of the application programs that reside on computing device 100. However, it will be understood that configuration debugging comparison application 200 can alternatively or additionally be embodied as computer-executable instructions on one or more computers and/or in different variations than shown on FIG. 1. Alternatively or additionally, one or more parts of configuration debugging comparison application 200 can be part of system memory 104, on other computers and/or applications 115, or other such variations as would occur to one in the computer software art.

Configuration debugging comparison application 200 includes program logic 204, which is responsible for carrying out some or all of the techniques described herein. Program logic 204 includes logic for acquiring snapshots from two (or more) systems to be compared 206; logic for using heuristics to compare the snapshot results from the systems 208; logic for generating comparison results based upon the heuristics 210; logic for displaying the comparison results in a manner that allows a user to see the differences 212; logic for providing a filtering feature to allow the user to further filter the results based on the type of issue to be diagnosed 214; logic for providing a requirements feedback feature to allow the user to add a user-identified difference to the system model as appropriate 216; and other logic for operating the application 220. In one implementation, program logic 204 is operable to be called programmatically from another program, such as using a single call to a procedure in program logic 204.

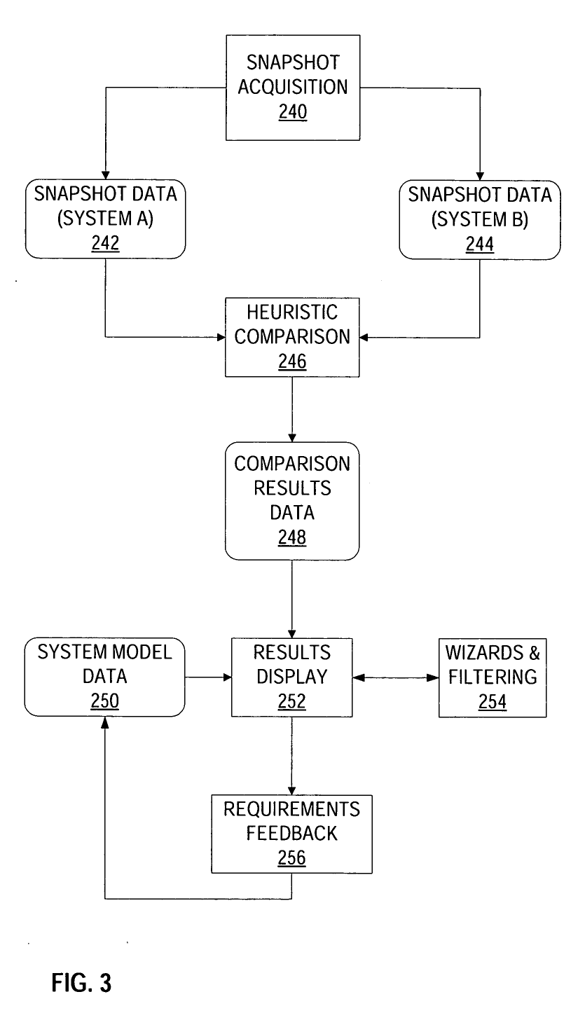

FIG. 3 is a logical diagram of a configuration debugging comparison application of FIG. 1 that illustrates one implementation of a process involved in performing a configuration comparison and the flow of data between processes. A snapshot acquisition feature 240 collects predefined information from two (or more) computer systems (e.g. from the computer system to use as the baseline and from the computer system that is not working properly). Snapshot data (242 and 244) is created for each of these computer systems and contains the attributes and settings that are likely to be relevant in diagnosing problems. A heuristic comparison feature 246 takes the two snapshots (242 and 244) and recursively compares the nodes. In one implementation, each node in the snapshot of the first computer system is compared to the equivalent node in the snapshot of the second computer system. In one implementation, a series of heuristics are used to check for logical equivalence when the node comparisons are made.

Alternatively or additionally, heuristics are performed to reduce and/or organize the comparison results data based upon differences that are “cumulative”. For example, suppose that if one value compares differently, there will also be three other values that will always be different as well. That primary value could be included in the comparison results file, but the other three could be eliminated to reduce the volume of data for the user to analyze. In this example, as long as the primary difference is reported, the other values are not required to be included for the user to understand the problem since they are “cumulative” of the same issue illustrated by the primary difference. This is just one non-limiting example, and it may not apply to all situations. Various other heuristics could also be used instead of or in addition to these.

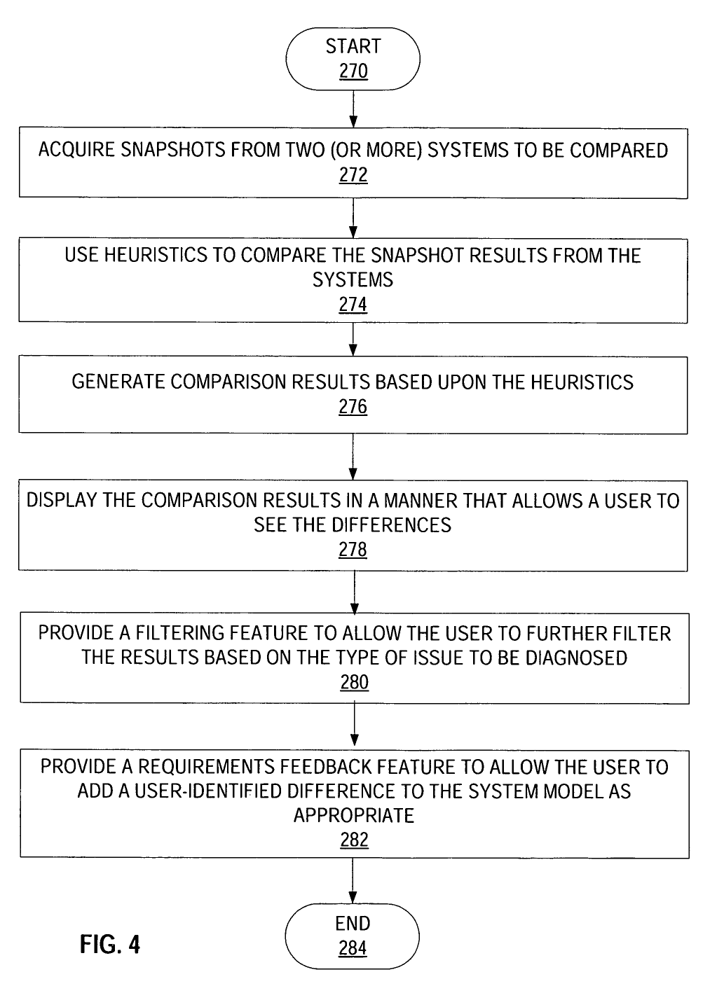

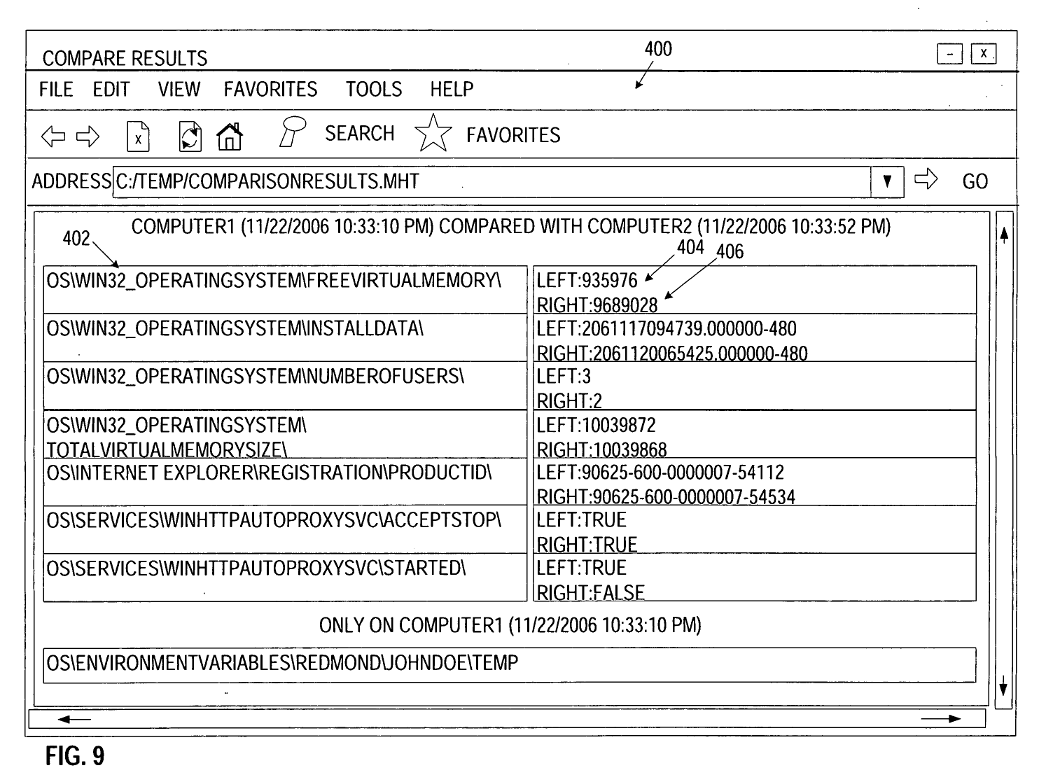

The comparison results data 248 is stored in a comparison results file (or other suitable output format). The comparison results data 248 is displayed in a results display 252 so the user can identify the differences in configuration between the two computer systems. The system model is a representation of the requirements and settings for a deployed system. The system model data 250 can be used to highlight in the results display 252 if any particular system requirements are not met. Wizards and filtering 254 allow the user to further refine the results that are displayed based upon the particular type of problem being diagnosed. In one implementation, a requirements feedback feature 256 is provided that indicates whether a user-identified difference is contained in the current system model 250 as a requirement. If it is not contained in the current system model, then the user optionally can add the particular requirement to the system model so it will be enforced as a system requirement in future comparisons. The features illustrated in FIG. 3 will now be described in further detail in the processes described in FIGS. 4-8, and the simulated screens of FIGS. 9-11.

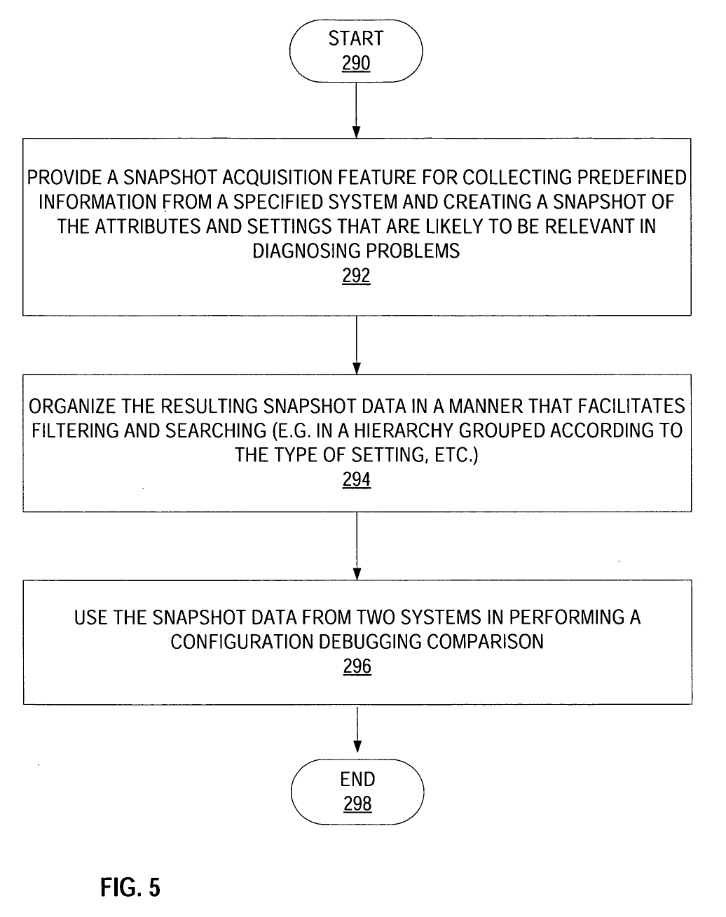

Turning now to FIGS. 4-8 with continued reference to FIGS. 1-3, the stages for implementing one or more implementations of configuration debugging comparison application 200 are described in further detail. FIG. 4 is a high level process flow diagram for configuration debugging comparison application 200. In one form, the process of FIG. 4 is at least partially implemented in the operating logic of computing device 100. The procedure begins at start point 270 with acquiring snapshots from two (or more) systems to be compared (stage 272). Heuristics are used to compare the snapshot results from the systems (stag 274). Comparison results are generated based upon the heuristics (stage 276). The comparison results are displayed in a manner that allows a user to see the differences (stage 278). A filtering feature is provided to allow the user to further filter the results based on the type of issue to be diagnosed (stage 280). A requirements feedback feature is provided to allow the user to add a user-identified difference to the system model as appropriate (stage 282). The process ends at end point 284. These high level stages will now be described in further detail in FIGS. 5-8.

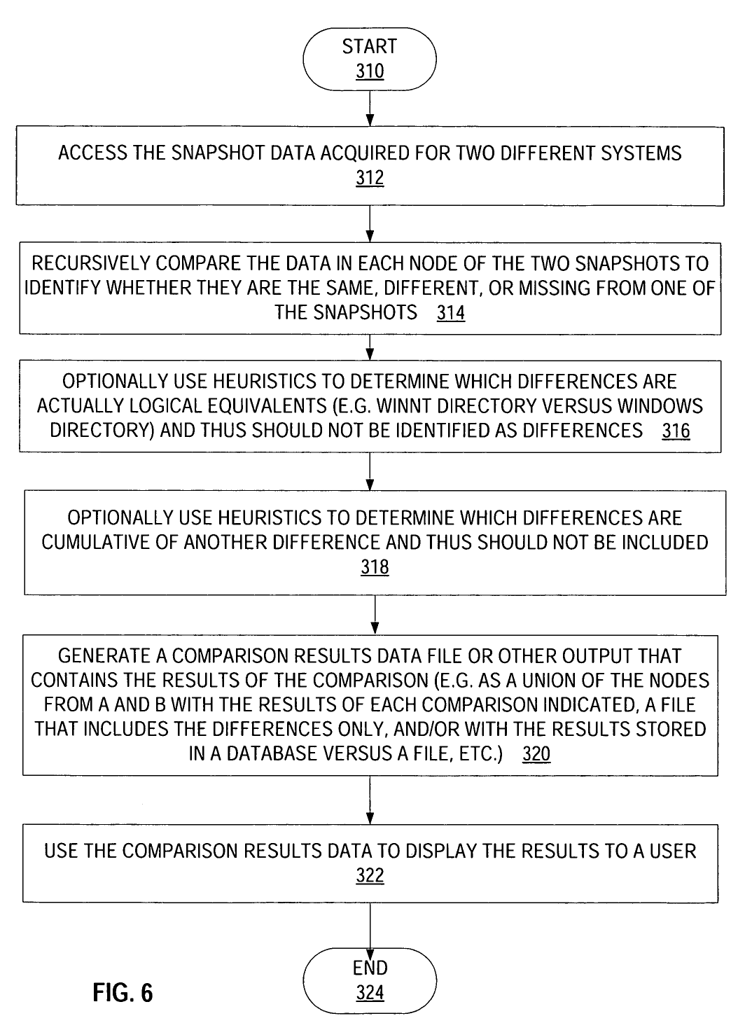

FIG. 5 is a process flow diagram that illustrates one implementation of the stages involved in providing a snapshot acquisition feature to capture predetermined configuration information from two (or more) systems. In one form, the process of FIG. 5 is at least partially implemented in the operating logic of computing device 100. The procedure begins at start point 290 with providing a snapshot acquisition feature for collecting predefined information from a specified system and creating a snapshot of the attributes and settings that are likely to be relevant in diagnosing problems (stage 292). The resulting snapshot data is organized in a manner that facilitates filtering and searching (e.g. in a hierarchy grouped according to the type of setting, etc.) (stage 294). The snapshot data is used from the two systems in performing a configuration debugging comparison (stage 296). The process ends at end point 298. The comparison feature will now be described in further detail in FIG. 6.

FIG. 6 is a process flow diagram that illustrates one implementation of the stages involved in comparing the snapshots from two systems to generate the configuration comparison results. In one form, the process of FIG. 6 is at least partially implemented in the operating logic of computing device 100. The procedure begins at start point 310 with accessing the snapshot data acquired for two different systems (stage 312). The data in each node of the two snapshots are recursively compared to identify whether they are the same, different, or missing from one of the snapshots (stage 314). Heuristics are optionally used to determine which differences are actually logical equivalents and thus should not be identified as differences (stage 316). One example of a logical equivalent is the same file that is contained in c:\Windows on one computer and d:\WinNT on another computer. Another example of a logical equivalent includes two different machine names contained in an identifier that is otherwise the same. Another logical equivalent might be numbers that are similar: such as 256 megabytes of memory versus 257 megabytes.

Heuristics are optionally used to determine which one or more differences are cumulative of another difference and thus should not be included (stage 318). One example of a cumulative difference is one where the same issue is already represented by another difference. In this scenario, although the difference is technically a true “difference”, by including it in the comparison results file as a difference, there is no further value provided to the user beyond another difference that is already being represented in the file. Thus, by eliminating it from the results reported as differences, the user can still discern the same problem by the other difference that still remains while having to analyze less information.

In some instances, it could make sense to treat these different numbers as the same “logically”. Another non-limiting example of a logical equivalent might be two values that differ only by their sentence case. For example, XXX could be treated as the same value as xxx or xxX. Various other types of logical equivalents could also be used to reduce the amount of differences identified depending on the type of data being compared.

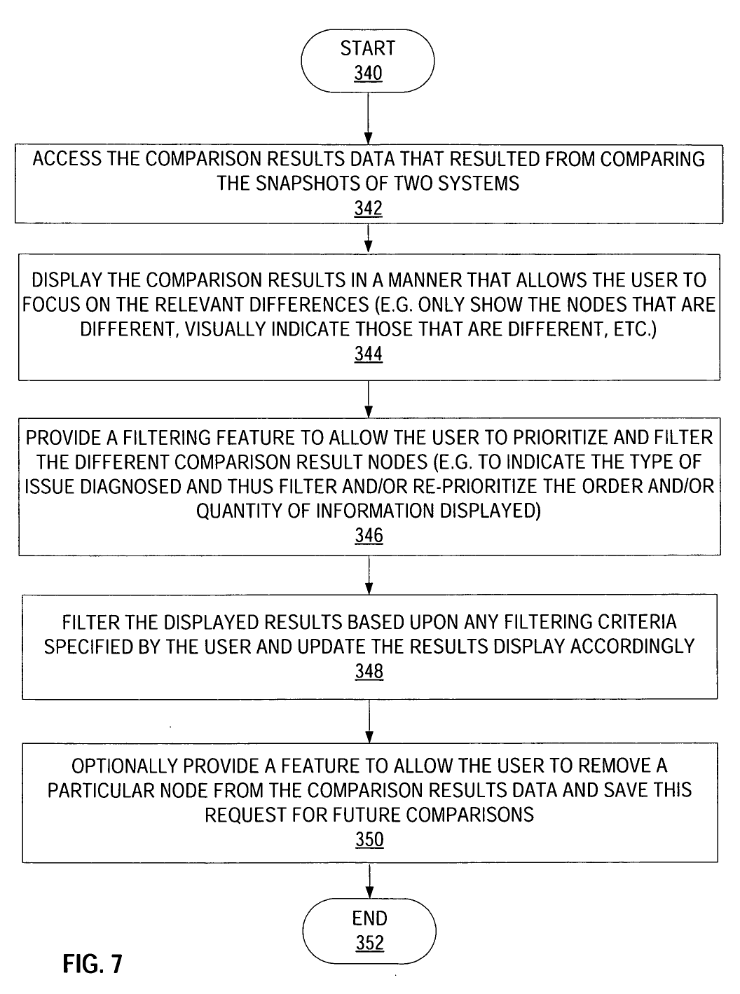

A comparison results data file or other output is generated that contains the results of the comparison (e.g. as a union of the nodes from computer A and computer B with the results of each comparison indicated, with a file that includes the differences only, and/or with the results stored in a database, etc.) (stage 320). The comparison results data is used to display the results to a user (stage 322) so the user can see the differences identified between the two computer systems. The process ends at end point 324. The display of comparison results to the user will now be described in further detail in FIG. 7.

FIG. 7 is a process flow diagram that illustrates one implementation of the stages involved in displaying the comparison results to the user in a format that allows the user to determine the configuration differences between the two systems. In one form, the process of FIG. 7 is at least partially implemented in the operating logic of computing device 100. The procedure begins at start point 340 with accessing the comparison results data that resulted from comparing the snapshots of two systems (stage 342). The comparison results are displayed in a manner that allows the user to focus on the relevant differences (e.g. by only showing the nodes that are different, visually indicating those that are different, allowing the user to quickly jump to the differences, etc.) (stage 344). A filtering feature is provided to allow the user to prioritize and filter the different comparison result nodes (e.g. to indicate the type of issue to be diagnosed and thus filter and/or re-prioritize the order and/or quantity of information displayed) (stage 346). The displayed results are then filtered based upon any filtering criteria specified by the user and the results display is updated accordingly (stage 348). A feature is optionally provided to allow the user to remove a particular node from the comparison results data and save the request to keep it from future comparisons (stage 350). The process ends at end point 352.

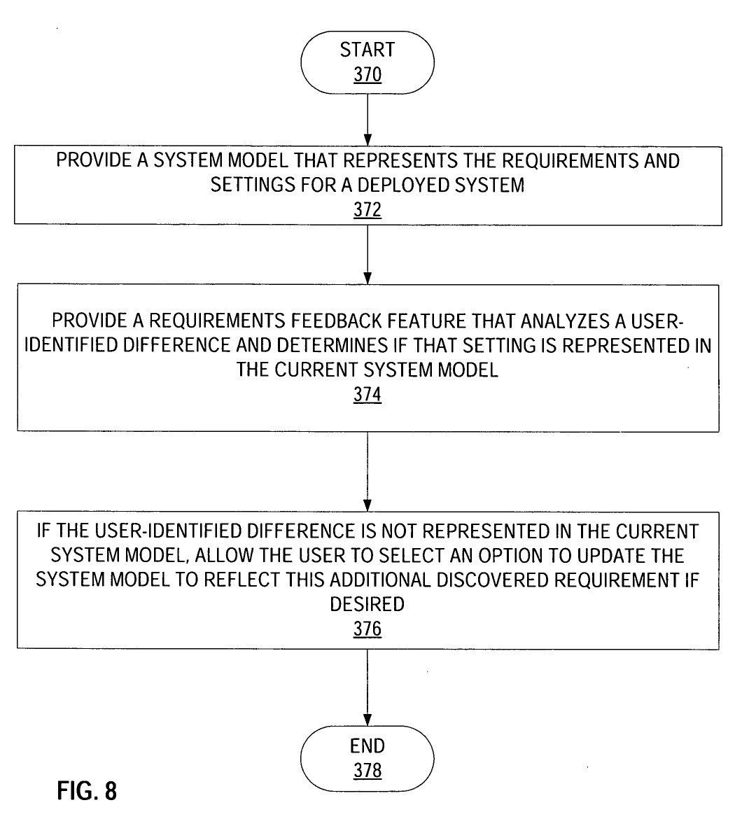

FIG. 8 is a process flow diagram that illustrates one implementation of the stages involved in providing a requirements feedback feature that allows the user to add a user-identified difference to the system model. In one form, the process of FIG. 8 is at least partially implemented in the operating logic of computing device 100. The procedure begins at start point 370 with providing a system model that represents the requirements and settings for a deployed system (stage 372). A few non-limiting examples of system requirements include a particular file that needs to exist, a particular database application that needs to be installed, a registry setting set to a specific value, etc. A requirements feedback feature is provided that analyzes a user-identified difference and determines if that setting is represented in the current system model (stage 374). In other words, the system analyzes the current system model to see if a particular difference identified by the user is contained as a system requirement. If the user-identified difference is not represented in the current system model, the user can select an option to update the system model to reflect the additional discovered requirements if desired (stage 376). By allowing the user to update the system model in this fashion, new requirements can be added to improve future comparisons based on the analysis the user has made in the current comparison. The process ends at end point 378.

Turning now to FIGS. 9-11, simulated screens are shown to illustrate a user interface to illustrate various exemplary features of configuration debugging comparison application 200. These screens can be displayed to users on output device(s) 111. Furthermore, these screens can receive input from users from input device(s) 112.

FIG. 9 shows a simulated screen 400 of one implementation that illustrates a comparison results data file being opened directly in a web browser. The file could be in one of various formats, such as XML, HTML, MHT, and various others. Alternatively or additionally, some of all of the comparison results data could be stored in a database. In the example shown in FIG. 9, the comparison file displays the results of the comparison between Computer1 and Computer2. The particular setting 402 is shown on the left side, and the value Computer1 (404) had for the setting 402 is shown above the value Computer2 (406) had for the setting 402. There are various other ways the values from the two systems could be presented, and the format shown in FIG. 9 is just a non-limiting example.

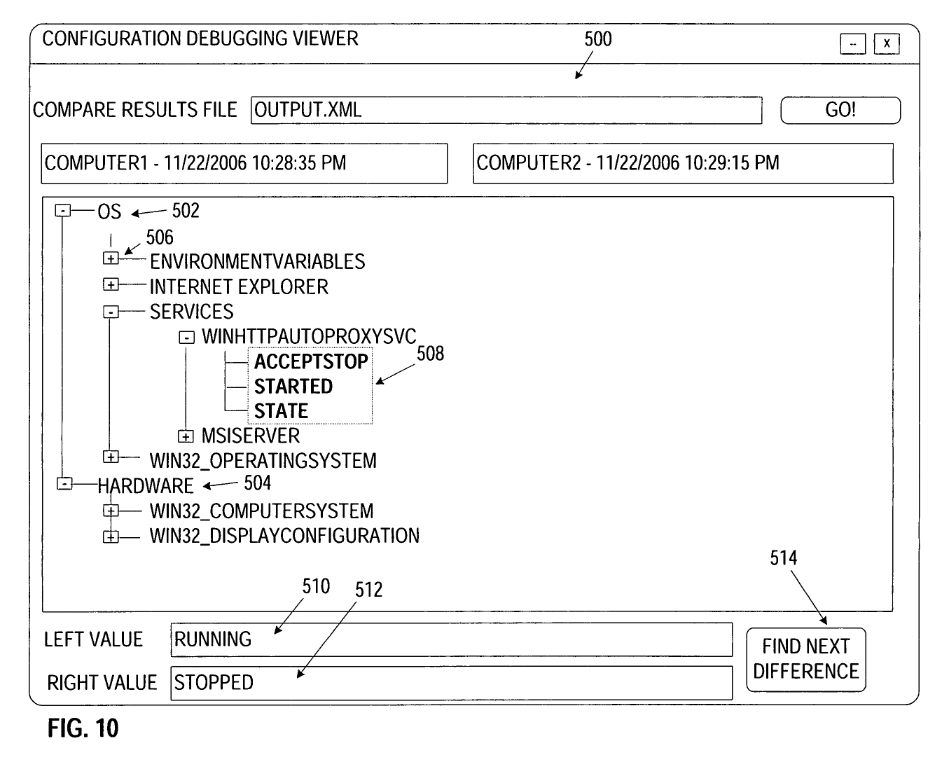

FIG. 10 shows a simulated screen 500 of one implementation that illustrates comparison results data being displayed according to the implied hierarchy of the data to display the differences in a meaningful fashion to the user. In the example shown, the results are grouped into two top level nodes: operating system settings 502 and hardware settings 504. There are nodes underneath the top level nodes, such as environment variables 506 under the operating system node 502. The differences are highlighted on the screen visually 508, so the user has a visual indication of the differences. The value that Computer1 has for the selected setting 510 is shown along with the value that Computer2 has for the selected setting 512. The user can select option 514 to find the next difference between the settings. In other implementations, other ways for visually indicating the differences and/or for displaying the comparison results could be used.

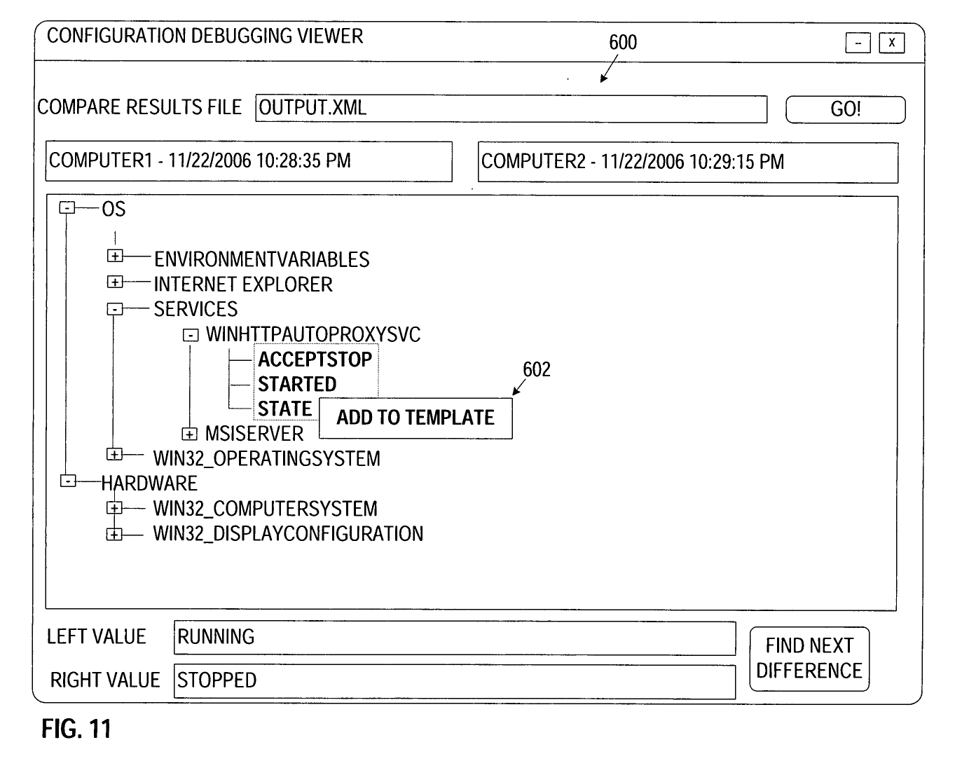

FIG. 11 shows a simulated screen 600 of one implementation that illustrates a requirements feedback feature that allows a user to update the system model with a particular requirement. If the user determines that a particular difference should be a system requirement to be used for future comparisons, then the user can select the option to add to the template 602 (e.g. to the system model). Upon adding the requirement to the system model, then future comparisons will look for this setting and will automatically indicate to the user if the particular system requirement is not met on either of the systems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for performing a configuration debugging comparison comprising the steps of:
acquiring snapshots from at least two computer systems to be compared;
comparing the snapshots from the computer systems;
generating comparison results based upon the comparison;
displaying the comparison results in a manner that allows a user to see one or more differences identified between the computer systems; and
providing a filtering feature to allow the user to further filter the comparison results based on a type of issue to be diagnosed.

2. The method of claim 1, wherein heuristics are used to determine if any of the one or more differences identified are logically equivalent.

3. The method of claim 2, wherein if a particular one of the differences identified is determined to be logically equivalent, then treating the particular one of the differences as though it is not a difference.

4. The method of claim 1, wherein the one or more differences comprises a plurality of differences, and wherein heuristics are used to eliminate at least one particular difference of the plurality of differences because that one particular difference is cumulative of a same issue that is already represented by another difference contained in the plurality of differences.

5. The method of claim 1, wherein the snapshots include settings that are likely to be relevant in diagnosing problems.

6. The method of claim 1, wherein the snapshots are organized in a manner that facilitates filtering and searching.

7. The method of claim 1, wherein the comparison results comprise a union of the snapshots of the systems with a comparison result for each comparison indicated.

8. The method of claim 1, wherein the comparison results comprise the one or more differences only.

9. The method of claim 1, wherein the comparison results are displayed in an updated fashion if a user uses the filtering feature to filter the comparison results based on the type of issue to be diagnosed.

10. The method of claim 1, further comprising:
providing a requirements feedback feature that allows a user to update a system model to reflect a user-identified requirement.

11. A computer-readable medium having computer-executable instructions for causing a computer to perform the steps recited in claim 1.

12. A system for performing configuration debugging comparisons comprising:
a snapshot acquisition feature that is operable to acquire snapshots of at least two computer systems;
a heuristic comparison feature that is operable to compare the snapshots of the computer systems and generating a comparison results output;
a results display feature that is operable to display the comparison results output; and
a filtering feature that is operable to allow a user to filter the comparison results output based on a type of problem being diagnosed.

13. The system of claim 12, further comprising:
a requirements feedback feature that is operable to allow the user to add a user-identified difference as a configuration requirement to a system model.

14. The system of claim 12, wherein the heuristic comparison feature is operable to identify at least one difference between the systems that are logically equivalent.

15. The system of claim 14, wherein the at least one difference that is identified as logically equivalent is not identified as a difference by the results display feature.

16. A method for performing a configuration debugging comparison comprising the steps of:
accessing snapshot data acquired for at least two computer systems;
comparing the snapshot data for a plurality of system settings to identify if one or more differences exist;
generating comparison results data that contains the results of the comparison;
using the comparison results data to display the results to a user; and
providing a requirements feedback feature for allowing the user to add a user-identified difference as a configuration requirement to a system model.

17. The method of claim 16, wherein the snapshot data comprises settings that are likely to be relevant in diagnosing configuration problems.

18. The method of claim 16, further comprising:
providing a filtering feature to allow the user to filter the comparison results data based upon a type of problem to be diagnosed.

19. The method of claim 16, further comprising:
if one or more differences are determined to exist, using heuristics to determine if any of the one or more differences are actually logically equivalents.

20. A computer-readable medium having computer-executable instructions for causing a computer to perform the steps recited in claim 16.
